(19) United States
(12) Patent Application Publication
(10) Pub. No.: US 2018/0270538 A1
(43) Pub. Date: Sep. 20, 2018

(54) INFORMATION PROCESSING DEVICE, CONTENT SELECTION SUPPORT METHOD AND CONTENT SELECTION SUPPORT PROGRAM

(71) Applicant: NEC PERSONAL COMPUTERS, LTD., Tokyo (JP)

(72) Inventor: KAZUHIRO NAKADA, TOKYO (JP)

(73) Assignee: NEC PERSONAL COMPUTERS, LTD., TOKYO (JP)

(21) Appl. No.: 15/891,200

(22) Filed: Feb. 7, 2018

(30) Foreign Application Priority Data
Mar. 15, 2017 (JP) 201750134

(51) Int. Cl. H04N 21/472; H04N 21/482; G06F 17/30; H04N 21/23

(52) U.S. Cl. CPC H04N 21/472; H04N 21/23; G06F 17/30029; H04N 21/482

(57) ABSTRACT

The present invention provides information which serves as a useful reference when selecting content in which a user himself/herself is interested in many pieces of content. An information processing device includes an information acquisition unit which acquires information that a third person who is related to a user contributes to a website, a content search unit which searches for content relating to the information which is acquired by the information acquisition unit, and a display control unit which makes a display unit display information on a plurality of pieces of content which is viewable for the user. The display control unit makes the display unit display the information on the content which is searched for by the content search unit in the information on the plurality of pieces of content in a state of being related to information corresponding to the third person.

### FIELD OF THE INVENTION

The present invention relates to an information processing device, a content selection support method and a content selection support program.

### BACKGROUND OF THE INVENTION

A system which is disclosed in, for example, Patent Document 1 is currently known as a technique of searching for content which would suit the taste of a user from within many pieces of content (for example, TV programs) and providing the searched content to the user.

In Patent Document 1, the system of analyzing the hobby and preference of the user on the basis of action history of the user, extracting pieces of the content which would suit the taste of the user on the basis of a result of analysis, and presenting the extracted pieces of content to the user by displaying a list of the extracted pieces of content is disclosed.

[Patent Document 1] Japanese Patent Application Laid-Open No. 2010-262534

### SUMMARY OF THE INVENTION

However, in the system disclosed in the above-described Patent Document 1, since the number of pieces of the action history which is stored is small at an initial stage, there is a possibility that a large deviation may occur in a search result.

In addition, in an existing method of presenting the search result to the user in the form of the list, there is a possibility that the content that the user wishes to view may not be contained in the pieces of content which are displayed in the form of the list. In such a case as described above, a necessity that the user himself/herself finds the content that the user wishes to view from within all pieces of the content including the pieces of content which are displayed in the form of the list and have already been confirmed may be induced.

The present invention has been made in view of such circumstances as described above and aims to provide an information processing device, a content selection support method, and a content selection support program making it possible to provide information which is useful when the user selects the content in which the user himself/herself is interested from within many pieces of the content.

The present invention adopts the following measures in order to solve the above-described issues.

An information processing device according to the first aspect of the present invention includes an information acquisition unit which acquires information that a third person who is related to a user contributes to a website, a content search unit which searches for content relating to the information which is acquired by the information acquisition unit, and a display control unit which makes a display unit display information on a plurality of pieces of content which is viewable for the user. The display control unit makes the display unit display, in the information on the plurality of pieces of content, the information on the content which is searched for by the content search unit in a state of being related to information corresponding to the third person.

A content selection support method according to the second aspect of the present invention includes the information acquiring step of acquiring information that a third party who is related to a user contributes to a website, the content searching step of searching for content relating to the acquired information, and the display controlling step of making a display unit display information on a plurality of pieces of the content which is viewable for the user. In the display controlling step, the information on the content which is searched for in the content searching step is displayed, in the information on the plurality of pieces of content, in a state of being related to information corresponding to the third person.

A content selection support program according to the third aspect of the present invention makes a computer execute an information acquiring process of acquiring information that a third party who is related to a user contributes to a website, a content searching process of searching for content relating to the acquired information, and a display controlling process of making a display unit display information on a plurality of pieces of the content which is viewable for the user. In the display controlling process, the information on the content which is searched for in the content searching process is displayed, in the information on the plurality of pieces of content, in a state of being related to information corresponding to the third person.

The above-described aspects of the present invention have such an effect that it is possible to provide the information which is useful when the user selects the content in which the user himself/herself is interested from within many pieces of the content.

### BRIEF DESCRIPTION OF THE DRAWINGS

FIG. 1 is a diagram illustrating one example of a configuration of the whole system which includes an information processing device according to one embodiment of the present invention.

FIG. 2 is a diagram illustrating one example of a hardware configuration of the information processing device according to one embodiment of the present invention.

FIG. 3 is a functional block diagram illustrating one example of main functions which are extracted as the functions which pertain to content selection support from functions that the information processing device, according to one embodiment of the present invention, has.

FIG. 4 is a flowchart illustrating one example of a procedure of content selection support processing which is executed by the information processing device according to one embodiment of the present invention.

### DETAILED DESCRIPTION OF THE INVENTION

In the following, an information processing device, a content selection support method, and a content selection support program according to embodiments of the present invention will be described with reference to the appended drawings.

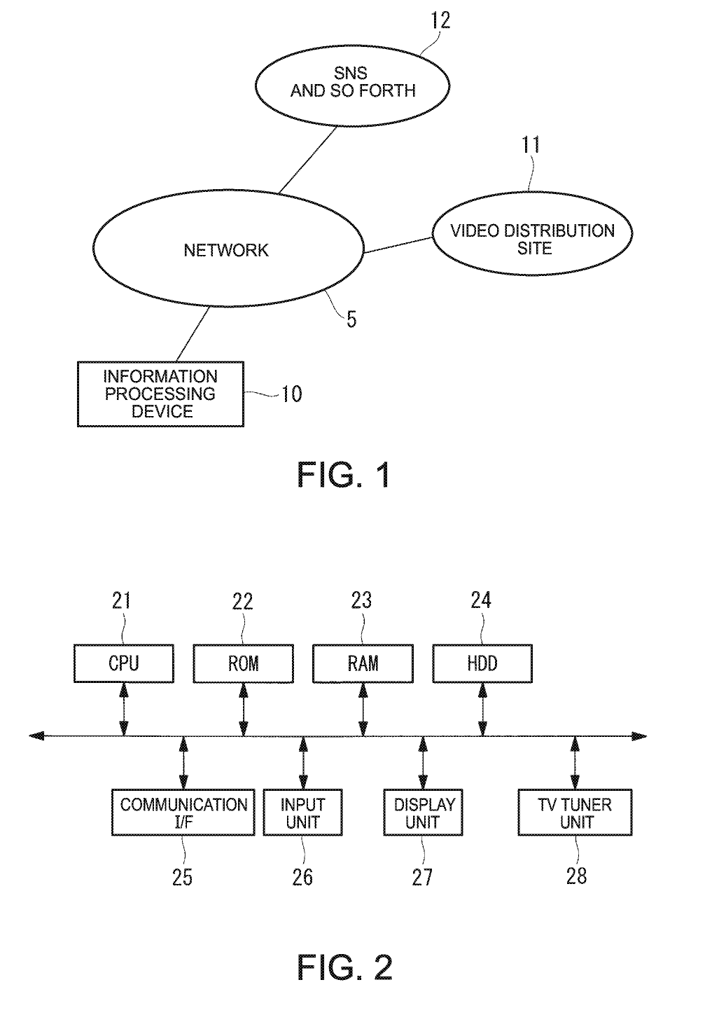

FIG. 1 is a diagram illustrating one example of a configuration of the whole system which includes an information processing device 10 according to one embodiment of the present invention. The information processing device 10 according to one embodiment of the present invention is, for example, a personal computer (in the following, called a “PC”), a portable information terminal such as a smartphone and so forth, a television receiver, a video recording and reproducing device such as a DVD recorder and so forth, and is configured to be connectable to a web server over a network 5 which is made widely connectable for the public such as the Internet and so forth.

The information processing device 10 is configured to be accessible to a social networking service such as Facebook (a registered trademark) and so forth (in the following, called an “SNS”), a communication network having social factors such as Twitter (a registered trademark) and so forth (in the following, the above-described services are collectively called “SNS and so forth” 12), and a video (a moving image) distribution site 11 such as Hulu (a registered trademark), YouTube (a registered trademark) and so forth.

FIG. 2 is a diagram illustrating one example of a hardware configuration of the information processing device 10 according to one embodiment of the present invention. As illustrated in FIG. 2, the information processing device 10 according to one embodiment of the present invention includes, for example, a CPU 21, a ROM (Read Only Memory) 22 which is adapted to store a program and so forth that the CPU 21 executes, a RAM (Random Access Memory) 23 which functions as a work area in execution of each program, a hard disk drive (HDD) 24 which works as a mass storage, a communication interface 25 which is adapted to connect the information processing device 10 to the network, an input unit 26, a display unit 27, a TV tuner unit 28 and so forth. The above-described units are connected to one another via a bus.

Incidentally, a storage medium which stores the program and so forth that the CPU 21 executes is not limited to the ROM 22. For example, other auxiliary storages such as a magnetic disk, a magneto-optical disk, a semiconductor memory and so forth may be used.

The CPU 21 is adapted to control operations of the whole of the information processing device 10 and loads a control program stored in the ROM 22, executes the program by developing the program on the RAM 23, and thereby realizes various functions which will be described later. The HDD 24 is adapted to store an application software program of the information processing device 10 and to record a TV program which is received by the TV tuner unit 28 and video content and so forth which is sent from the video distribution site. In addition, in a case where recording reservation and so forth is made by a user, the HDD 24 stores information on a program for which recording reservation is made.

The communication interface 25 is used to connect the information processing device 10 to the network 5 such as the Internet and so forth and to establish bidirectional communication between the information processing device 10 and a web server which is connected to the network 5.

The input unit 26 is, for example, a keyboard, a mouse, a touch panel, a remote controller and so forth and is used by the user to give instructions to the information processing device 10.

The display unit 27 is, for example, a liquid crystal display and displays a result of the application software program executed by the CPU 21, the TV program received by the TV tuner unit 28, and the video content received from the video distribution site 11 via the communication interface 25. Incidentally, the display unit may be provided integrally with the information processing device 10 and/or may be connected to the information processing device 10 via a predetermined cable and so forth as an external device.

The TV tuner unit 28 receives a broadcast which is transmitted from a broadcast station by a terrestrial digital broadcasting system, a BS (Broadcasting Satellite) system, a CS (Communications Satellite) system and so forth through an antenna and demodulates the received broadcast.

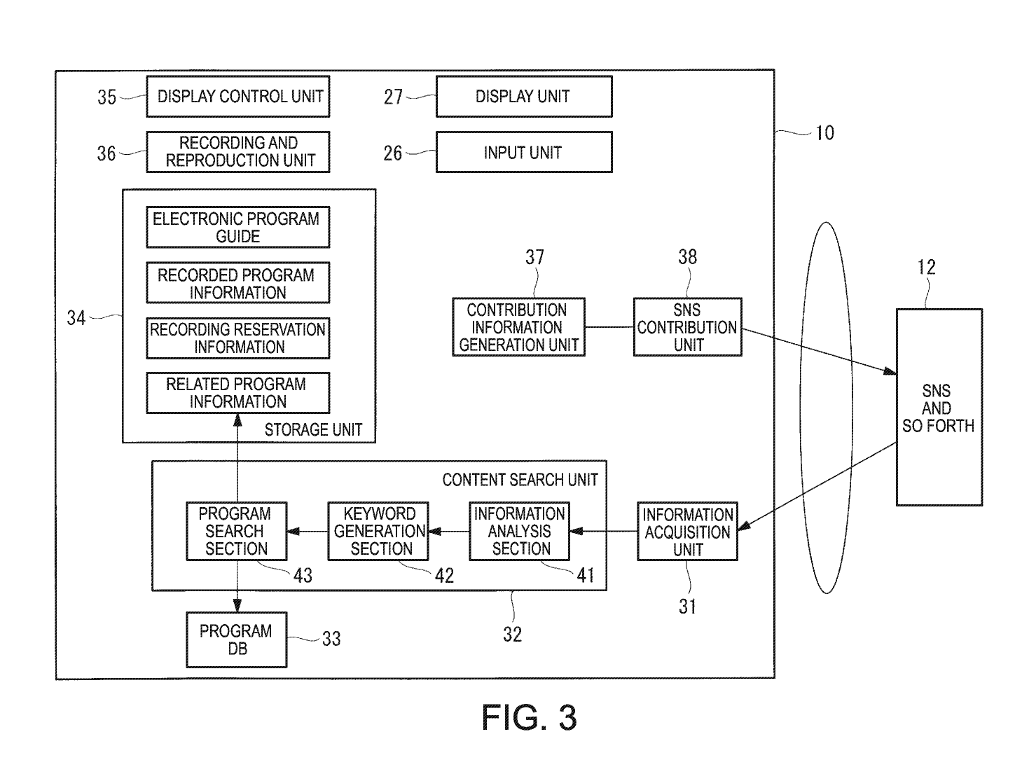

FIG. 3 is a functional block diagram illustrating one example of main functions which are extracted as the functions which pertain to content selection support from functions that the information processing device 10 according to one embodiment of the present invention has. Incidentally, the above-described CPU 21 reads out a content selection support program stored in the ROM 22 and so forth on the RAM 23, and executes the content selection support program so read-out and, as a result, various functions which are performed by respective units which will be described later are realized.

As illustrated in FIG. 3, the information processing device 10 includes an information acquisition unit 31, a content search unit 32, a program database 33, a storage unit 34, a display control unit 35, a recording and reproduction unit 36, a contribution information generation unit 37, an SNS contribution unit 38, the input unit 26, the display unit 27 and so forth.

The information acquisition unit 31 has a storage (illustration is omitted) in which information of the SNS such as Facebook (the registered trademark) and so forth for which the user signs up and registers, information of Twitter (the registered trademark) for which the user signs up and registers, and information of a third person who is related to the user. Here, as the information of the SNS and so forth 12 for which the user himself/herself signs up and registers, for example, URLs and so forth of the above-described websites may be given. In addition, as the third person who is related to the user, for example, an operator of a blog that the user follows, a person who is registered as a friend, a community and so forth may be given.

The information acquisition unit 31 gains access to the SNS and so forth 12 on the basis of the above-described pieces of information which are stored in the storage (not illustrated) and acquires various kinds of information such as a profile, a contributed article, a contributed image and so forth of the user; and a profile, a contributed article, a contributed image and so forth of the third person who is related to the user. For example, the information acquisition unit 31 may acquire the above-described various kinds of information by periodically gaining access to a target website and/or, in a case where the user requests to display programs in an electronic program guide (EPG) and so forth, may acquire the above-described various kinds of information by using the request as a trigger.

The content search unit 32 searches the program database 33 to find a program (content) relating to the information acquired by the information acquisition unit 31. For example, the content search unit 32 includes an information analysis section 41, a keyword generation section 42 and a program search section 43. The information analysis section 41 analyzes the information acquired by the information acquisition unit 31 and extracts a term which would become a keyword, for example, a noun. The keyword generation section 42 generates the keyword from the terms extracted by the information analysis section 41 and specifies a category. For example, in a case where the terms which are extracted from one contributed article are “Italy”, “traveling”, “west”, “electric train” and so forth, the keyword generation section 42 specifies “traveling” as the category and generates “Italy” as the keyword considering from a relationship among the above-described terms in accordance with a predetermined algorithm. In addition, for example, in a case where the terms extracted from another contributed article are “game”, “soccer”, “stadium” and so forth, the keyword generation section 42 specifies “sport” as the category and generates “soccer” as the keyword considering the relationship among the above-described terms. Incidentally, a well-known technique may be appropriately used as a keyword generation method.

The program search section 43 searches the program database 33 on the basis of the keyword and the category which are respectively generated and specified by the keyword generation section 42 and extracts information on the program which is high in relationship with the keyword and the category. Here, information on programs and distributed videos which are viewable for the user are stored in the program database 33. For example, these pieces of information are information which is periodically downloaded from program servers that respective broadcast stations provide and servers of various video distribution sites. Incidentally, the information processing device 10 may possess such a database as described above and, alternatively, the program search section 43 may gain access to a webserver which distributes the above-described programs and so forth over the network 5 and may extract information on the program relating to the keyword and the category generated and specified by the keyword generation section 42 by performing a search on the webserver. Incidentally, the information on the program (information on the content) extracted by the program search section 43 may be information on the basis of which specification of the program is possible and contains, for example, the program name. In addition, the information may be information containing the broadcast station, the time for the program and so forth and further may be metadata and so forth containing various pieces of information on the cast and so forth of the program.

The information searched for and extracted by the content search unit 32 is stored in the storage unit 34 as related program information in a state of being related to the information of the user or the third person such as the contributed article thereof and so forth used in extraction of the program. The electronic program guide (EPG), recorded program information, recording reservation information and so forth are stored in the storage unit 34 in addition to the above-described related program information.

In a case where an instruction to display the electronic program guide is input from the user, the display control unit 35 reads the information to be displayed as the electronic program guide out of the storage unit 34 and makes the display unit 27 display the read-out information as the electronic program guide on a display screen of the display unit 27. In addition, in a case where there is a program which is registered as the related program information in the programs displayed on the display screen, the display control unit 35 makes the display unit 27 display the program in the electronic program guide in a state of being related to information corresponding to the user and/or the third person. Here, as one example of the information corresponding to the user and/or the third person, for example, a profile image(s) used when the person and/or the community sign(s) up and resister(s) for the SNS and so forth 12 is/are given. Incidentally, a manner of displaying the information of the user and/or the third person is not limited to the above-described example and may be displayed in such a manner that the contributor of the contributed article and so forth used to search for the program is recognized. For example, color information on each of the user and the third person may be registered in advance to see that the program is extracted on the basis of whose information by coloring the frame of the program concerned in the electronic program guide.

In addition, in a case where a specific program is designated by the user from within the electronic program guide displayed on the display screen and an input instruction for viewing the program is input from the input unit 26, the display control unit 35 makes the display unit 27 display the designated program and makes the display unit 27 display a screen used for recording reservation.

In addition, likewise, in a case where an instruction to display a list of recorded programs is input from the user, the display control unit 35 reads the recorded program information out of the storage unit 34 and makes the display unit 27 display the recorded program information in the form of the list. Then, in a case where there is the program which is registered as the related program information in the programs in the list, the display control unit 35 makes the display unit 27 display the program in a state of being related to the information of the person and/or the community corresponding to the program. In addition, in a case where an instruction to display a recording reservation list is input from the user, the display control unit 35 reads recording reservation information out of the storage unit 34 and makes the display unit 27 display the read-out recording reservation information in the form of the list. Then, in a case where there is the program which is registered as the related program information in the programs in the list, the display control unit 35 makes the display unit 27 display the program in a state of being related to the information of the person and/or the community corresponding to the program.

For example, in a case where the specific program is designated from within the list of recorded programs which is displayed on the display unit 27, and an instruction to view the specific program so designated is input from the input unit 26, the recording and reproduction unit 36 reproduces the recorded program so designated and makes the display unit 27 display the recorded program.

For example, in a case where an input instruction for contribution to the SNS is input by depressing an SNS contribution button which is provided on the input unit 26 and so forth while the user is viewing a TV program, video content and so forth, the contribution information generation unit 37 acquires information on the program that the user is currently viewing and so forth from the electronic program guide and so forth and draws up default of an article to be contributed on the basis of the acquired information. Drawing-up of the default is possible by describing various kinds of information acquired from the electronic program guide and so forth in accordance with the format of the default which is prepared in advance. The SNS contribution unit 38 uploads the article to be contributed which is generated by the contribution information generation unit 37 to the SNS site. Thereby, the article to be contributed is automatically drawn up and is contributed to a page of the SNS site of the user.

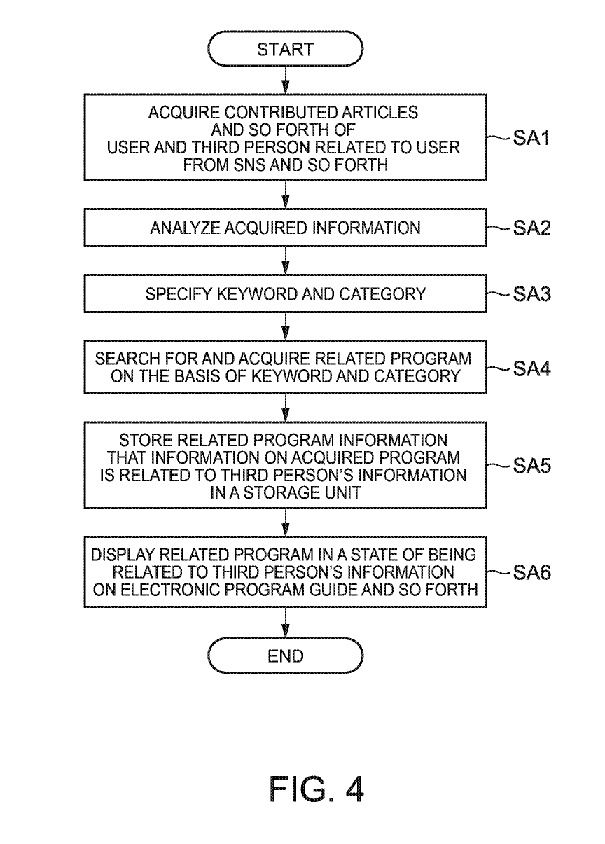

Then, operations of the information processing device 10 according to one embodiment of the present invention will be described with reference to FIG. 4. FIG. 4 is a flowchart illustrating one example of a procedure of content selection support processing which is executed by the information processing device 10 according to one embodiment of the present invention.

First, the information acquisition unit 31 gains access to the SNS and so forth 12 and acquires information such as the contributed articles and so forth of the user and third persons (for example, a friend A and a friend B) who are related to the user (step SA1). The content search unit 32 analyzes the contributed articles and so forth acquired by the information acquisition unit 31 (step SA2), generates the keyword and specifies the category (step SA3), searches the program database 33 using the generated keyword and the specified category and acquires information on the related program, in other words, program specification information for specifying the related program (step SA4). The acquired information on the related program is stored in the storage unit 34 as the related program information in a state of being related to the information of the third persons (step SA5).

Then, in a case where the input unit 26 is operated by the user and thereby, for example, the instruction to display the electronic program guide is input, the display control unit 35 acquires information to be displayed from within the information on the electronic program guide stored in the storage unit 34 and acquires the related program information stored in the storage unit 34. Then, the display control unit 35 makes the display unit 27 display the program which is registered in the related program information in a state of being related to the information of the third persons in the electronic program guide (step SA6). Thereby, in the electronic program guide, the program which is related to the contributed articles of the user and the third persons (for example, the friend A and the friend B) who are related to the user are displayed in a state of being related to the information of the friend A and the friend B, for example, on the display screen of the display unit 27. Thereby, it becomes possible to inform the user of the programs that the user's friends wish to recommend to the user and the programs relating to the hobbies and preferences of the friends on the electronic program guide and thereby it becomes possible for the user to utilize these pieces of information as reference information in selection of the program.

Then, in a case where the user operates the input unit 26 in a state where the electronic program guide is being displayed and thereby an instruction to view the specific program is input, the designated program is displayed on the display unit 27. In addition, in a case where an instruction to record the program is input in place of the instruction to view the program, recording reservation of the designated program is executed.

In addition, in a case where an instruction to perform SNS contribution is input from the input unit 26 while the user is viewing the program, an article to be contributed relating to the program that the user is currently viewing is automatically drawn up by the contribution information generation unit 37 and is uploaded to the SNS website by the SNS contribution unit 38. Thereby, it becomes also possible to support contribution of the article to the SNS in addition to program selection support using the information of the SNS website.

As described above, according to the information processing device, the content selection support method and the content selection support program according to the embodiments of the present invention, the program guide that the programs that the user himself/herself and/or the friends and others who are related to the user recommend(s) and the programs relating to the hobbies and preferences of the friends are related to the information of the user and/or his/her friends is displayed on the display unit 27. Thereby, it becomes possible for the user to know the programs that the persons who are registered as the friends in the SNS and so forth 12 are interested in or programs that the user would assume that the persons are interested in and then it becomes possible for the user to use the programs as the reference information in program selection while browsing the program guide. In addition, according to the embodiments of the present invention, since the list that recommended programs are extracted in advance in accordance with the hobby and preference of the user is not displayed as has ever been displayed and information that such program extraction as described above is not performed, for example, the electronic program guide itself is displayed on the display unit 27, it is possible to solve such an issue that the program which would attract the user's interest is not present in the list of the extracted programs.

As described above, according to the information processing device, the content selection support method and the content selection support program according to the embodiments of the present invention, it is possible to provide the information (the useful information) which would be helpful in a case where the user selects the program to view from within many programs and thereby it is possible to support program selection.

Although in the above-described embodiments, description is made by exemplifying the TV program as one example of the content, the content is not limited to the TV program. For example, the content may be the video content which is distributed from the video distribution site. In this case, a list of a plurality of distributed videos which is viewable for the user is displayed on the display screen and, in addition, the distributed videos acquired by the content search unit 32 are displayed in a state of being related to the information (for example, the profile image) corresponding to the third persons on the display screen. In addition, the content is not limited to such programs, distributed videos and so forth as described above and may be, for example, article content which is distributed from a media server and so forth and/or may be music content provided from a music distribution site. In addition, the content may be advertisement content which is distributed from an advertisement server. Incidentally, in a case where the TV program is not contained as the content, it is possible to regard the TV tuner unit 28 (see FIG. 2) in the information processing device 10 as a configuration which is optionally installed.

Although, in the foregoing, the present invention is described by using the above-described embodiments, the technical range of the present invention is not limited to the range described in the above-described embodiments. The above-described embodiments may be modified and improved in a variety of ways within a range not deviating from the gist of the present invention, and aspects so modified and improved are also included in the technical range of the present invention. In addition, the above-described embodiments may be appropriately combined with one another.

1. An information processing device comprising:
an information acquisition unit which acquires information that a third person, who is related to a user, contributes to a website;
a content search unit which searches for content relating to the information which is acquired by the information acquisition unit; and
a display control unit which makes a display unit display information on a plurality of pieces of content which is viewable for the user, wherein:
the display control unit makes the display unit display, in the information on the plurality of pieces of content, the information on the content which is searched for by the content search unit and which is related to information corresponding to the third person.

2. The information processing device according to claim 1, wherein:
the content is a broadcast program which is distributed from a broadcast station,
the content search unit acquires information on the broadcast program relating to the information which is acquired by the information acquisition unit from a program database in which information on the broadcast program is stored, and
the display control unit makes the display unit display, at least part of information on a plurality of broadcast programs as a program guide, a list of recording reserved programs or a list of recorded programs, and makes the display unit display, in the program guide, the list of recording reserved programs or the list of recorded programs, information on the broadcast program which is searched for by the content search unit and which is related to the information corresponding to the third person.

3. The information processing device according to claim 1, wherein:
the content is a distributed video which is distributed from a video distribution server, and
the display control unit makes the display unit display a list of at least part of information on a plurality of viewable distributed videos, and makes the display unit display information on the distributed video which is searched for by the content search unit and which is related to the information corresponding to the third person.

4. The information processing device according to claim 1, wherein:
the information acquisition unit acquires at least one of an article, a profile, and an image that the third person who is related to the user contributes to a social networking service.

5. The information processing device according to claim 1, further comprising:
an input unit which can designate at least one piece of the information on the plurality of pieces of content displayed on the display unit.

6. The information processing device according to claim 1, wherein:
the information acquisition unit acquires information that the third person contributes to the website and information that the user contributes to the website, and
the display control unit makes the display unit display the information on the content which is searched for by the content search unit in the plurality of pieces of content and which is related to each of the information corresponding to the third person and the information corresponding to the user.

7. A content selection support method comprising:
an information acquiring step of acquiring information that a third party who is related to a user contributes to a website;
a content searching step of searching for content relating to the acquired information; and
a display controlling step of making a display unit display information on a plurality of pieces of the content which is viewable for the user, wherein:
in the display controlling step, the information on the content which is searched for in the content searching step is displayed, in the information on the plurality of pieces of content, and which is related to information corresponding to the third person.

8. A content selection support program making a computer execute:
an information acquiring process of acquiring information that a third party who is related to a user contributes to a website;
a content searching process of searching for content relating to the acquired information; and
a display controlling process of making a display unit display information on a plurality of pieces of the content which is viewable for the user, wherein:
in the display controlling process, the information on the content which is searched for in the content searching process is displayed, in the information on the plurality of pieces of content, and which is related to information corresponding to the third person.
